(19) United States
(12) Patent Application Publication
(10) Pub. No.: US 2006/0000316 A1
(43) Pub. Date: Jan. 5, 2006

(54) Wrench with socket engaged by coupling shaft protruded from wrench body

(76) Inventor: Chih-Ching Hsieh, Taichung Hsien (TW)

Correspondence Address: Chih-Ching Hsieh, 235 Chung-Ho, Box 8-24, Taipei, TW

(21) Appl. No.: 11/211,874

(22) Filed: Aug. 26, 2005

Related U.S. Application Data
(63) Continuation-in-part of application No. 10/300,376, filed on Nov. 21, 2002, now abandoned.

(51) Int. Cl. B25B 13/00

(52) U.S. Cl. 81/52

(57) ABSTRACT

An engaging device of a sleeve-form wrench comprises a spanner body and a sleeve. On an outer peripheral surface of the coupling shaft, a plurality of convex buckling portions and concave surface portions are arranged along an axial periphery of the coupling shaft; the convex buckling portions and concave surface portions have cambered shapes and are connected one by one; an inner wall of the sleeve is formed with concave arc portions with respect to the convex buckling portions and convex arc portions with respect to the concave surface portion so that the coupling shaft are inserted thereinto. By above structure the spanner body and the sleeve are combined tightly; moreover, the sleeve suffers a larger twisting force from the spanner body and the stress distributes uniformly.

The present invention is a continuation in part of U.S. patent application Ser. No. 10/300,376, assigned and invented to the inventor of the present invention. Therefore the content of the invention is incorporated into the present invention as a part of the present invention.

### BACKGROUND OF THE INVENTION

1. Field of the Invention

The present invention relates to wrenches, and particularly to an engaging device of a sleeve-form wrench.

2. Description of Related Art

Referring to FIGS. 1 and 2, the coupling shafts of prior art wrenches are illustrated. The prior art coupling shafts have rectangular shapes or hexagonal shapes. The surfaces of the coupling shafts are plane surfaces. In general, the coupling shaft and sleeve can not be well engaged and thus the twisting force can not be concentrated and unwanted friction occurs (referring to FIG. 3).

To improve the defect of the prior art, referring to FIGS. 4 and 5, a third prior art is illustrated. A buckle is formed on the periphery of a coupling shaft and an inner surface of the sleeve is formed with a corresponding structure so that the sleeve and coupling shaft are engaged more firmly. However, the twisting force can not be well transferred to an object to be rotated and the stress is concentrated at some places.

With reference to FIG. 6, it is illustrated that a prior art coupling shaft is coupled to a sleeve. It is shown that the coupling between the two has a 90 degree structure, as indicated in b. When the spanner twists the sleeve to drive the nut, the transfer of twisting force will disperse because the stress is concentrated on some points. For a long time, gaps will generate these points.

Referring to FIGS. 7 and 8, another prior art is shown. In this embodiment, the engagement of the sleeve and coupling shaft is similar to that of above embodiment. For example, as shown in FIG. 8, the convex portions of the coupling shaft has a flat surface and the concave portions have a concave shape. Thereby the connection of the convex portion and the concave portion is formed with an angle near 90 degrees, as c point indicated in FIG. 9. Thereby, not only when the sleeve is taken down, the rubber ring will drop out, but also the twisting force can not be well transferred. As a result these prior arts are necessary to be improved.

### SUMMARY OF THE INVENTION

Accordingly, the primary object of the present invention is to provide an engaging device of a sleeve-form wrench comprising a spanner body and a sleeve. On an outer peripheral surface of the coupling shaft, a plurality of convex buckling portions and concave surface portions are arranged along an axial periphery of the coupling shaft; the convex buckling portions and concave surface portions have cambered shapes and are connected one by one; an inner wall of the sleeve is formed with concave arc portions with respect to the convex buckling portions and convex arc portions with respect to the concave surface portion so that the coupling shaft are inserted thereinto. By above structure, the spanner body and the sleeve are combined tightly; moreover, the sleeve suffers a larger twisting force from the spanner body and the stress distributes uniformly.

The various objects and advantages of the present invention will be more readily understood from the following detailed description when read in conjunction with the appended drawing.

### BRIEF DESCRIPTION OF THE DRAWINGS

FIG. 1 is an exploded schematic view of a first prior art.

FIG. 2 is an exploded perspective view of a second prior art.

FIG. 3 is a cross section view showing one operation of the second prior art.

FIG. 4 is an exploded perspective view of a third prior art.

FIG. 5 shows another embodiment of the third prior art.

FIG. 6 is an assembled schematic cross sectional view of the third prior art.

FIG. 7 is an exploded schematic view of a fourth prior art.

FIG. 8 is an exploded perspective view of a fifth prior art.

FIG. 9 is a schematic view showing that a rubber ring is installed in the fifth prior art.

FIG. 10 is a schematic view of the present invention.

FIG. 11 is an exploded schematic view of the present invention.

FIG. 12 is a schematic cross sectional view of the present invention.

FIG. 13 is a schematic view of another embodiment of the present inrtvcntion.

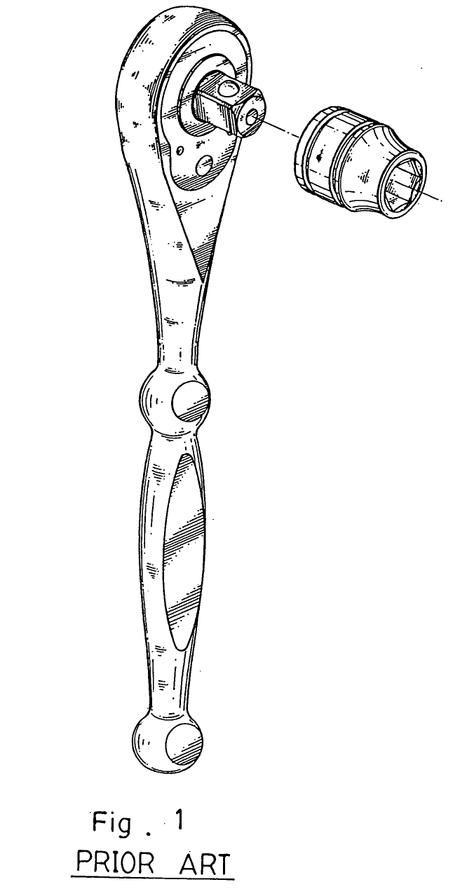

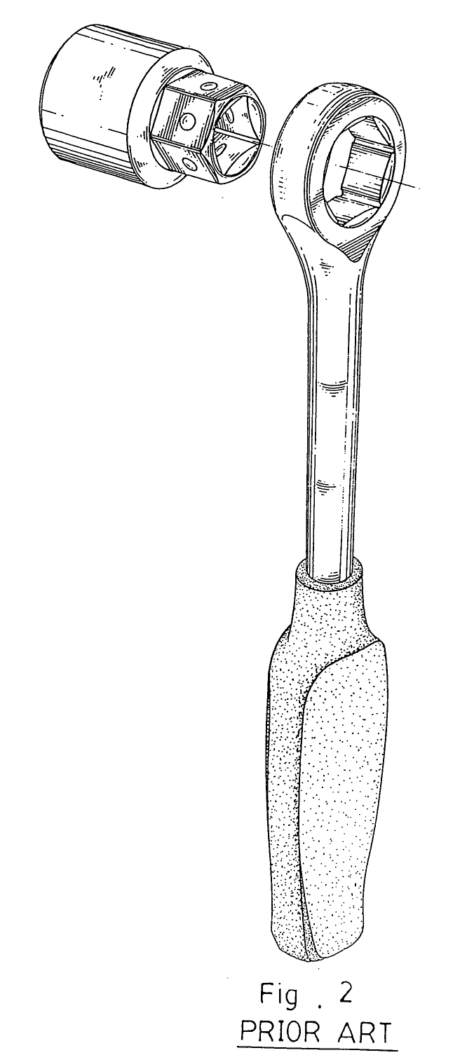

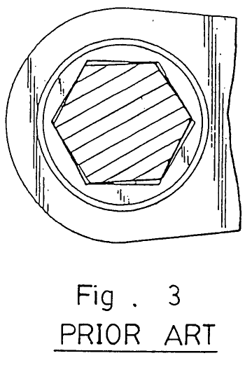

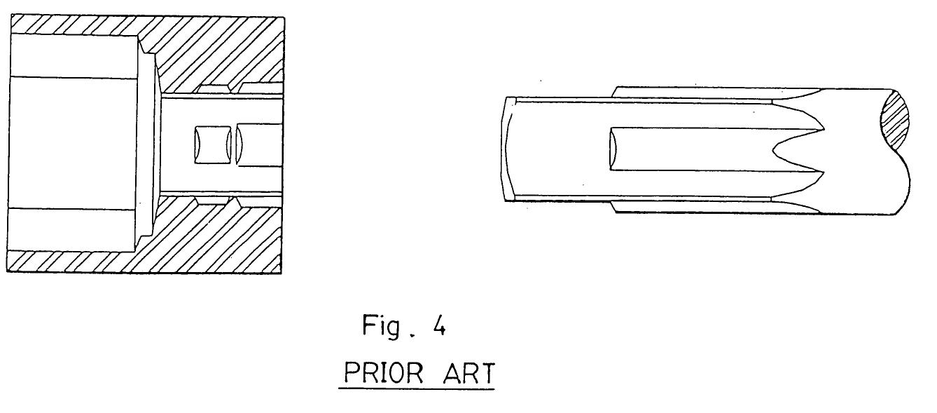

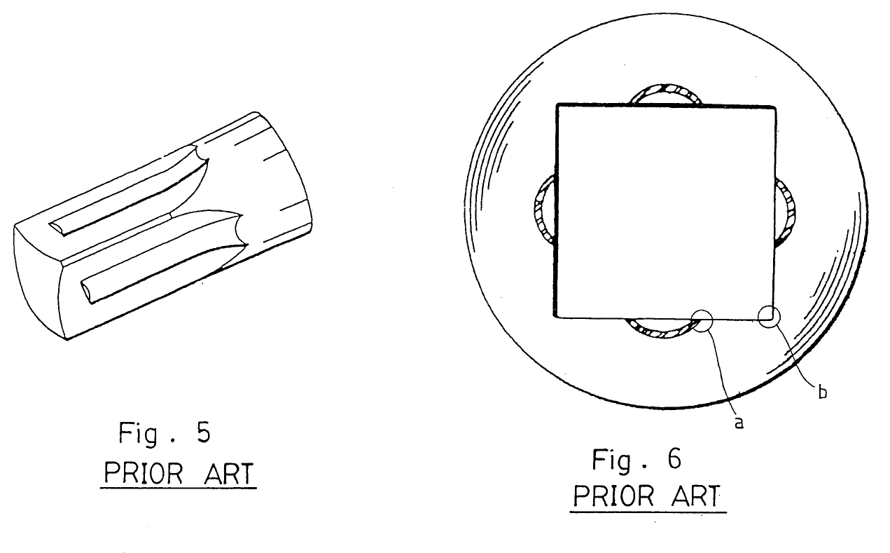

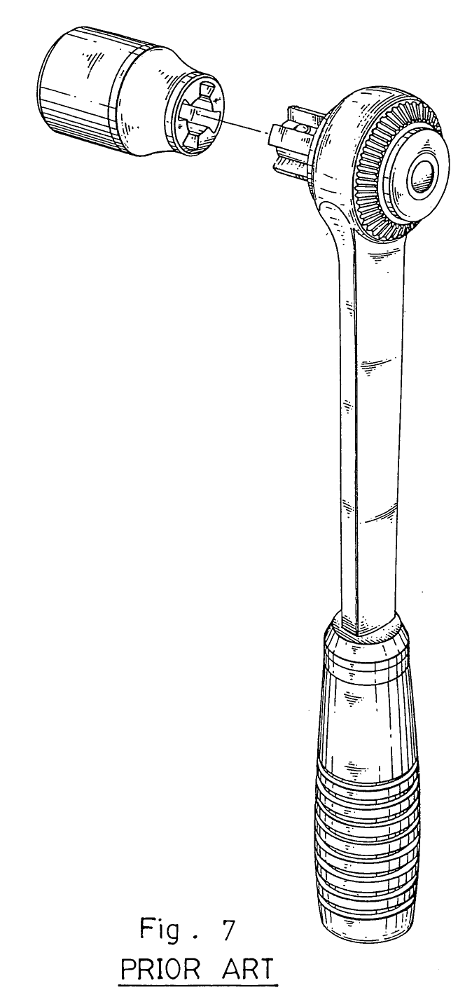

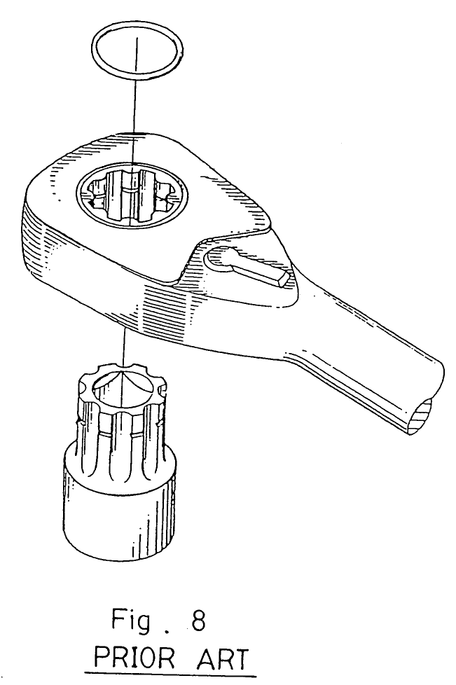

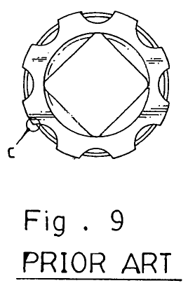

### DETAILED DESCRIPTION OF THE PREFERRED EMBODIMENTS

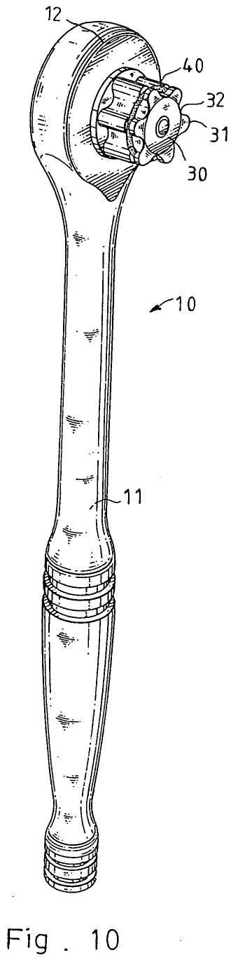

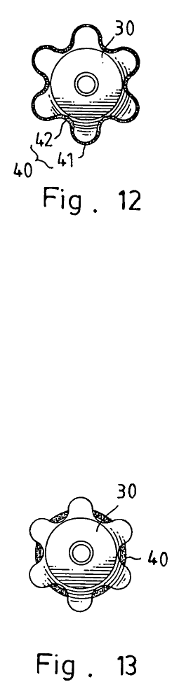

Referring to FIGS. 10 to 12, the engaging device of a sleeve-form wrench of the present invention is illustrated. The engaging device of a sleeve-form wrench includes a spanner body 10 and a sleeve 20. One end of the spanner body 10 with respect to the handle 11 is formed with a head portion 12. The head portion 12 is installed with a ratchet element (not shown). A coupling shaft 30 is protruded from the head portion 12 for being engaged with a sleeve 20. A tightening element 40 encloses the coupling shaft 30.

On an outer peripheral surface of the coupling shaft 30, a plurality of convex buckling portions 31 and concave surface portions 32 are arranged along the axial periphery of the coupling shaft 30. The convex buckling portions 31 and concave surface portions 32 have cambered shapes and are connected one by one. A notch 33 is formed along the axial periphery of the coupling shaft 30 for being enclosed by a tightening element 40.

The sleeve 20 is a prior art sleeve. The inner wall of the sleeve 20 is formed with concave arc portions 21 with respect to the convex buckling portions 31 and convex arc portions 22 with respect to the concave surface portion 32 so that the coupling shaft 30 can be inserted thereinto. The sleeve 20 is formed with a groove 23 in the inner surface thereof.

The tightening element 40 has a configuration corresponding to that of the coupling shaft 30 and thus has convex portions 41 and concave portions 42. When the tightening element 40 is engaged with the coupling shaft 30, the tightening element 40 is exactly buck led to the notch 33 and slightly protruded from the surface of the coupling shaft 30. The engagement of the tightening element 40 and the coupling shaft 30 are tightly so that no gap is formed therebetween.

Thereby, by above structure, the spanner body 10 and the sleeve 20 are combined tightly. Moreover, the sleeve can suffer a larger twisting force from the spanner body and the stress will not concentrate at some places. Referring to FIG. 13, the tightening element 40 on the coupling shaft 30 can be used to a round coupling shaft 30.

In one embodiment of the present invention, there are six convex buckling portions and six concave surface portions.

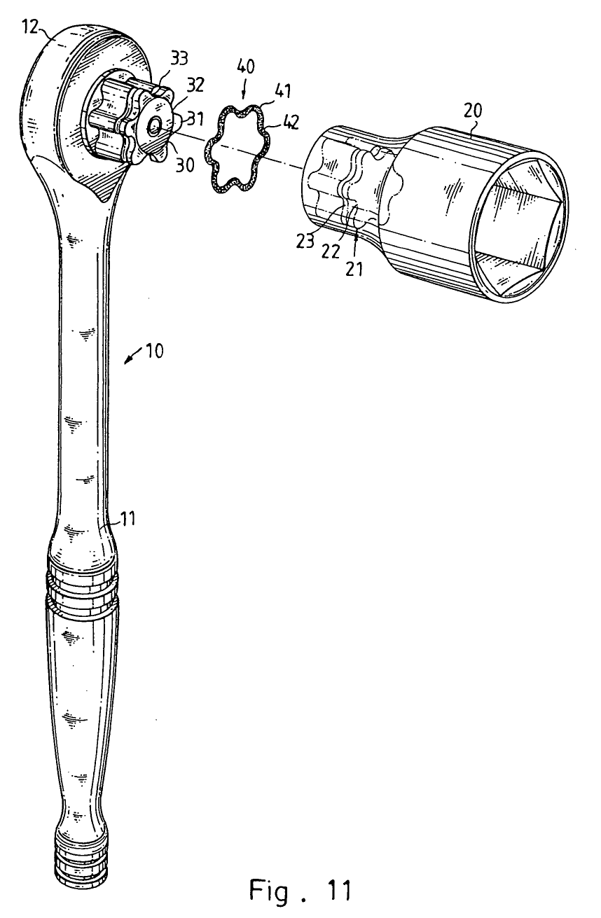

Moreover referring to FIG. 11 of the present invention, a middle section of the handle 11 has a plurality of annular recesses. Thereby the user can hole the handle firmly.

The advantages of the present invention will be described hereinafter:

1. Since the tightening element 40 is engaged to and completely adhered to the coupling shaft 30, when the coupling shaft 30 is coupled to the sleeve 20, not only the tightening element 40 will not drop out, but also the coupling shaft 30 and sleeve 20 are tightly coupled.

2. Since the convex buckling portion 31 and concave surface portion 32 of the coupling shaft 30 are connected one by one, and the concave arc portion 21 and convex arc portion 22 of the sleeve 20 are connected one by one. The stress induced from twisting an object will not corecentrate at some critical points so that the strength of the spanner is improved.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. An engaging device of a sleeve-form wrench comprising a spanner body and a sleeve; wherein
one end of the spanner body with respect to the handle is formed with a head portion; the head portion being installed with a ratchet element;
a coupling shaft being protruded from the head portion for being engaged with a sleeve; on an outer peripheral surface of the coupling shaft, a plurality of convex buckling portions and concave surface portions are arranged along an axial periphery of the coupling shaft; the convex buckling portions and concave surface portions have cambered shapes and are connected one by one;
an inner wall of the sleeve is formed with concave arc portions with respect to the convex buckling portions and convex arc portions with respect to the concave surface portion so that the coupling shaft are inserted thereinto;
wherein by above structure, the spanner body and the sleeve are combined tightly; moreover the sleeve suffers from a larger twisting force from the spanner body and the stress distributes uniformly.

2. The engaging device of a sleeve-form wrench as claim in claim 1, wherein a notch is formed along an axial periphery of the coupling shaft for being enclosed by a tightening element; the tightening element has a plurality of convex portions and a plurality of concave portions.

3. The engaging device of a sleeve-form wrench as claim in claim 1, wherein the tightening element has a round periphery.

4. The engaging device of a sleeve-form wrench as claim in claim 1, wherein the tightening element has a configuration corresponding to that of the coupling shaft and thus has convex portions and concave portions; when the tightening element is engaged with the coupling shaft, the tightening element is exactly buck led to the notch and slightly protruded from the surface of the coupling shaft; the engagement of the tightening element and the coupling shaft are tightly so that no gap is formed therebetween.

5. The engaging device of a sleeve-form wrench as claim in claim 4, wherein there are six convex buckling portions and six concave surface portions.

6. The engaging device of a sleeve-form wrench as claim in claim 5, wherein a middle section of the handle 11 has a plurality of annular recesses.
